(19) United States
(12) Patent Application Publication
(10) Pub. No.: US 2024/0302887 A1
(43) Pub. Date: Sep. 12, 2024

(54) ASSET CONTROLLER FOR SELECTIVE OPERATION OF ASSETS

(71) Applicant: Swanbarton Limited, Malmesbury (GB)

(72) Inventors: Clive Tomlinson, Bradford-on-Avon (GB); David Mutch, Bradford-on-Avon (GB); Anthony Price, Sherston (GB); Andrew Scott, Bath (GB)

(21) Appl. No.: 18/667,264

(22) Filed: May 17, 2024

Related U.S. Application Data
(63) Continuation of application No. PCT/GB2022/052875, filed on Nov. 11, 2022.

(30) Foreign Application Priority Data
Nov. 17, 2021 (GB) 2116585.7

(51) Int. Cl. G06F 1/3287

(52) U.S. Cl. CPC G06F 1/3287

(57) ABSTRACT

An asset controller 1 is configured to selectively operate each of a plurality of fast-and slow-response assets 8, 9 in response to demand therefore, such that the slow-response asset 9 can be supported by a fast-response asset 8 at the start of a time-shift operation, to deliver the required response immediately and during the slow-response asset's 9 response time.

### RELATED APPLICATIONS

This application claims the benefit under 35 U.S.C. § 120, and is a continuation, of co-pending International Application PCT/GB2022/052875, filed Nov. 11, 2022 and designating the US, which claims priority to GB Application 2116585.7, filed Nov. 17, 2021, such GB Applications also being claimed priority to under 35 U.S.C. § 119. These GB and International applications are incorporated by reference herein in their entireties.

### FIELD

The present invention relates generally to an asset controller for selective operation of assets and a method of controlling said assets and finds particular, although not exclusive, utility in managing power on an electrical network.

### BACKGROUND

Parties sometimes wish to time-shift their consumption (and production) of electric energy, for reasons including: maximizing their use of their own renewably generated electricity; reducing consumption at times of day when suppliers' prices are high; shifting export of energy to times of day when buying prices are high; engaging in power network balancing services; mitigating local power shortages (for example in a microgrid or when the grid supply is constrained); and mitigating local power surplus (for example in a microgrid or when the grid is unable to transmit photovoltaic energy away fast enough, as sometimes happens in UK), or otherwise constrained.

The time-shifting required can vary in duration: in some contexts, it may be sufficient to shift a 30-second power peak, while in other contexts a shift of several hours is necessary. Equally, the magnitude of consumption (production) power to be shifted can vary.

For many parties there is a mix of relatively short duration (often low energy) requirements and relatively long duration (often high energy) requirements.

### SUMMARY

According to a first aspect of the present invention, there is provided an asset controller configured to selectively operate each of a plurality of assets in response to demand therefore, the asset controller comprising: a load determination unit configured to establish power consumption on a network; a database comprising, for each of the plurality of assets, a unique identifier and an associated response-time; a processor configured to identify at least two of the plurality of assets to operate, in response to the established network power consumption, wherein a first one of the at least two of the plurality of assets has a first response-time significantly less than a second response-time of a second one of the at least two of the plurality of assets; and control means configured to individually instruct each of the at least two of the plurality of assets to operate, in response to identification thereof by the processor.

In this way, an energy store or load with a relatively high response-time can be supported by a co-located asset controller such that relatively low response-time loads can be switched on or off at the start of a time-shift operation, to deliver the required response immediately and during the energy store's (or high response-time load's) response time. Similarly, a generator with relatively high response time and/or minimum run time can be supported by a co-located asset controller such that relatively low response-time generators, stores and/or loads can be switched on or off at the start of a time-shift operation, to deliver the required response immediately and during the generator's response time.

An asset may comprise any generator or power generation unit, load or power consumption unit, and/or store or power storage unit. For example, an asset may comprise a refrigerator, a heater (e.g. water heater or space heater), a battery (e.g. lithium-ion, lead-acid, sodium-sulphur, flow battery, etc.), a flywheel, pumped hydropower, compressed air energy storage, pumped heat energy storage, cryogenic storage, a hydrogen electrolyser, a fuel cell, diesel generator, biomass generator, hydrogen and/or liquefied natural gas generator, renewable generator (e.g. wind, water, wave, tidal, solar, etc.).

There may be only two such assets, or more than two from which the processor may identify an appropriate two. There may be at least three, five, ten, a hundred, etc.

Selectively operate may mean instruct to operate of each asset independently of any other asset, based upon appropriate identification thereof.

Demand may be established by the load determination unit, and may be based upon the established power consumption on the network. Alternatively or additionally, demand may be established by other means, such as by a trigger signal from another asset, a determination of a time of day, and/or manual input.

The load determination unit may determine a load, for instance an electrical load on a network, and it may do this by direct means (e.g. sensing current and/or voltage characteristics on the network, and/or frequency) and/or indirect means (e.g. algorithmically, and/or by prediction, and/or by reference to predetermined values such as those contained in look-up tables). Establishing may comprise determining by any of the above-mentioned means, amongst others.

The power consumption on a network may comprise the electrical load on a network.

The asset controller, the load determination unit, the processor and/or the control means may comprise physical components and/or may be embodied in virtual/software elements. In this way, the asset controller and/or components thereof may be located locally and/or remotely (for instance on the cloud and accessible over a communications network such as the internet). The database may be stored locally, or stored remotely, for instance on the cloud and accessible over a communications network such as the internet.

The unique identifier may simply comprise a numeric identifier or name.

The response-time(s) may comprise the typical time from an operational instruction being sent by the processor (and/or being received by the asset) to the asset deemed as having carried out the operational instruction. For example, electrical loads may often be switched on and off relatively quickly (for example within a few microseconds); however, with many technologies, response-times may be a matter of seconds or even minutes; some technologies (such as some forms of generators) may have relatively slow response-times (for example many minutes).

The operational instruction may comprise an instruction to activate and/or deactivate, and/or an instruction to limit consumption and/or generation. Similarly, the state of operating of an asset may comprise activation, deactivation, and/or a stated limited consumption and/or generation having been met.

The processor may comprise a computer processor or other equivalent system.

Identifying an asset may comprise selecting an asset from a list, for example from the database.

The least two assets may be only two, or two or more, for instance three, four, five, etc.

The first response-time being significantly less than the second response-time may comprise the first response-time being more than a factor of two less than the second response time, in particular more than a factor of ten less than the second response time, more particularly more than a factor of 100 less than the second response time.

The control means may comprise a communications transmitter to send an instruction to the respective assets. Alternatively, the control means may comprise control circuitry and/or switch(es) to isolate or connect the respective assets from or to the network.

The processor may be configured to individually instruct each of the at least two of the plurality of assets to activate/deactivate, in response to identification thereof by the processor.

The processor may be configured to instruct the first one of the at least two of the plurality of assets to deactivate/activate, once the second one of the at least two of the plurality of assets has been activated/deactivated.

In this way, both assets may be instructed by the control means, but the relatively low response-time asset may be used to fill-in for the delay in the relatively high response-time asset becoming activated.

With any energy storage technology there is some loss of energy when it is stored and then retrieved; round-trip losses of 10-20% are not unusual. In addition, with any energy storage technology there is some wear-and-tear cost of storage and retrieval operations; with some technologies that cost is negligible but with others it can be significant.

In addition, the efficiency of storage in certain types of energy store can depend on the energy store's charging or discharging rate. For example, a lead acid battery which is discharged at a high rate has a lower effective energy storage capacity than the same battery discharged at a slower rate. Accordingly, the asset controller may be configured to maximize a benefit of storage by managing loads in order to optimize efficiency, so that the energy store is charged or discharged at a favourable/optimal (or more nearly optimal) rate. In certain arrangements, the asset controller may enable use of a first energy store to support a second energy store. For example, a supercapacitor (having relatively small energy capacity, but a comparatively very fast response) may be used to support a cryogenic store (having relatively high capacity, but comparatively slow response), and/or a lithium-ion battery may be used to support a lead-acid battery.

The processor may be configured to individually instruct each of the at least two of the plurality of assets to activate/deactivate at different times.

For example, the first one of the at least two of the plurality of assets may be instructed significantly before or significantly after the second one of the at least two of the plurality of assets.

Significantly before/after may comprise more than a factor of two more than the first response time, in particular more than a factor of ten more than the second response time, more particularly more than a factor of 100 more than the second response time.

In this way, unnecessary activation of an energy store with relatively high round trip losses and/or wear-and-tear cost can be avoided by delaying its activation. The asset controller can therefore accommodate small and/or brief operations, to avoid the wear-and-tear costs and/or energy losses of conventional energy storage operations.

In addition, some generators require a certain minimum run time once they're turned on, or at least work most efficiently (or with least maintenance costs) if run for at least a certain time. Accordingly, it is desirable to avoid their use when not strictly necessary.

A time between instruction of the at least two of the plurality of assets to activate/deactivate may be equal to a predetermined maximum controlled time of one of the at least two of the plurality of assets, less a response-time of the other of the at least two of the plurality of assets.

For example, a refrigerator (or other low response-time load) may be deactivated immediately to enable a network load to be reduced, and that load may be left off for as long as safely possible (e.g. before there is a risk to the refrigerator contents) before a diesel generator is required to be activated.

According to a second aspect of the present invention, there is provided a method of controlling assets on a network, the method comprising the steps of: providing a plurality of assets on a network; providing an asset controller according to the above; the load determination unit establishing power consumption on the network; the processor identifying at least two of the plurality of assets to operate, in response to the established network power consumption, wherein a first one of the at least two of the plurality of assets has a first response-time significantly less than a second response-time of a second one of the at least two of the plurality of assets; and the control means individually instructing each of the at least two of the plurality of assets to operate, in response to identification thereof by the processor.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is a representation of an asset controller in a network.

FIG. 2 is a representation of an asset controller in a network.

### DETAILED DESCRIPTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other. For instance, wireless connectivity is contemplated.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the invention may be combined in any suitable manner with any other particular feature, structure or characteristic of another embodiment or aspect of the invention, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

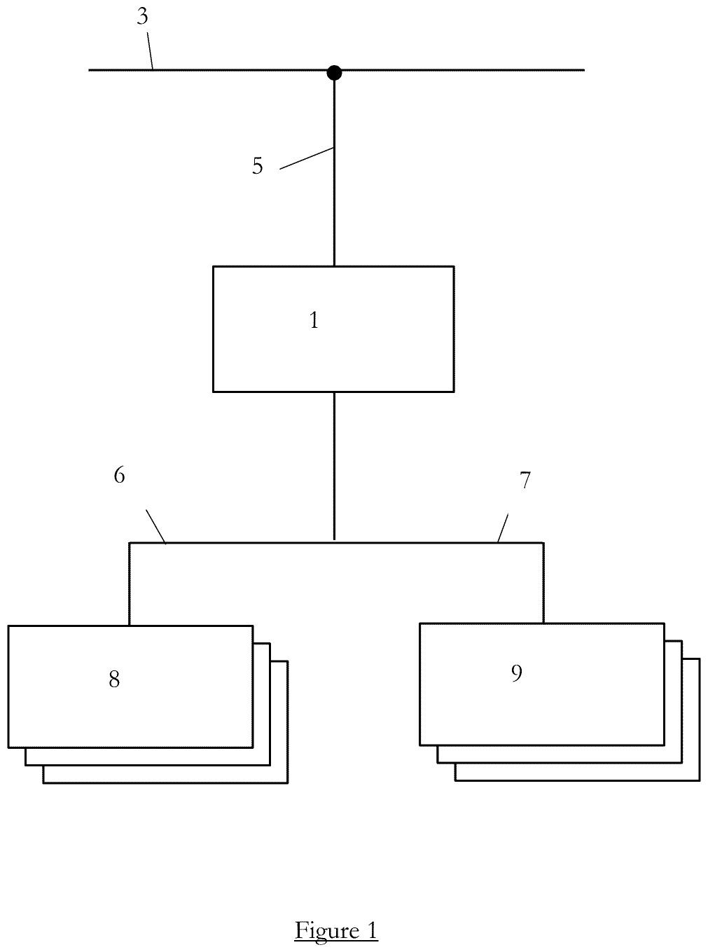

FIG. 1 is a representation of an asset controller 1 connected to a network 3 by network connection 5. The asset controller 1 is additionally connected via first and second asset connections 6, 7 to a plurality of fast-response assets 8 and a plurality of slow-response assets 9, respectively.

Specifically, the asset controller 1 is located between the network 3 and the fast- and slow-response assets 8, 9, such that connection of the fast- and slow-response assets 8, 9 to the network 3 is mediated by the asset controller 1.

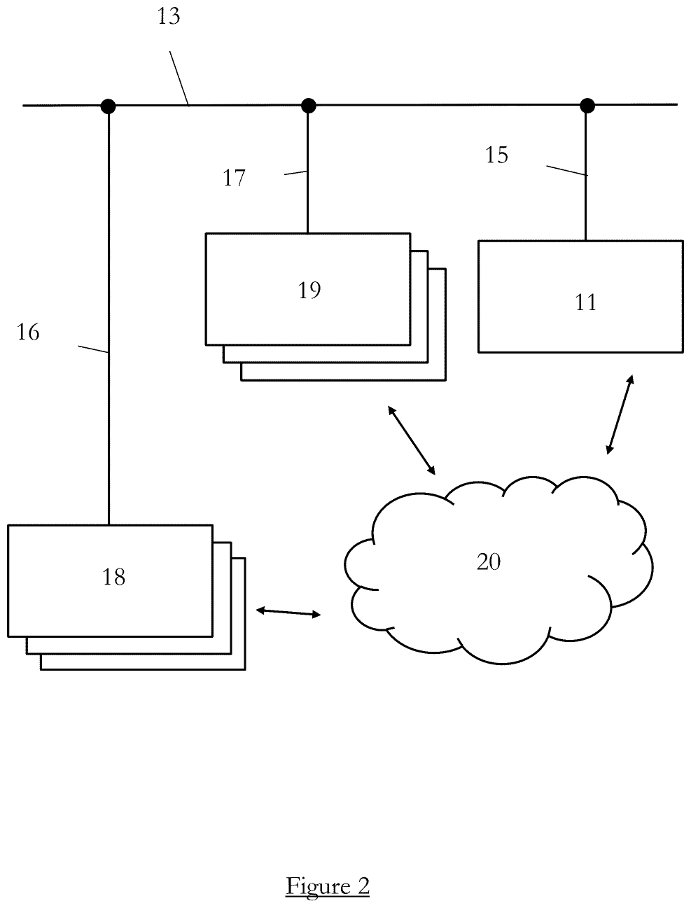

FIG. 2 is an alternative representation of an asset controller 11 connected to a network 13 by network connection 15. Additionally, a plurality of fast-response assets 18 are connected to the network 13 via a first connection 16, and a plurality of slow-response assets 19 are connected to the network 13 via a separate and distinct second connection 17.

In this arrangement, the asset controller 11 does not mediate the connection between the fast- and slow-assets 18, 19 and the network 13, but instead communicates with each of the fast- and slow-assets 18, 19 via a communications network 20, to control operation thereof.

It is to be appreciated that the asset connection 6, 7, 16, 17 may comprise a single connection, a branching connection, or a plurality of separate and distinct sub-connections such that each of the plurality of assets is provided with its own connection.

1. An asset controller configured to selectively operate each of a plurality of assets in response to demand therefore, the asset controller comprising:
a load determination unit configured to establish power consumption on a network;
a database comprising, for each of the plurality of assets, a unique identifier and an associated response-time;
a processor configured to identify at least two of the plurality of assets to operate, in response to the established network power consumption, wherein a first one of the at least two of the plurality of assets has a first response-time significantly less than a second response-time of a second one of the at least two of the plurality of assets; and
control means configured to individually instruct each of the at least two of the plurality of assets to operate, in response to identification thereof by the processor.

2. The asset controller of claim 1, wherein the processor is configured to individually instruct each of the at least two of the plurality of assets to activate/deactivate, in response to identification thereof by the processor.

3. The asset controller of claim 2, wherein the processor is configured to instruct the first one of the at least two of the plurality of assets to deactivate/activate, once the second one of the at least two of the plurality of assets has been activated/deactivated.

4. The asset controller of claim 3, wherein the processor is configured to individually instruct each of the at least two of the plurality of assets to activate/deactivate at different times.

5. The asset controller of claim 4, wherein a time between instruction of the at least two of the plurality of assets to activate/deactivate is equal to a predetermined maximum controlled time of one of the at least two of the plurality of assets, less a response-time of the other of the at least two of the plurality of assets.

6. A method of controlling assets on a network, the method comprising the steps of:
providing a plurality of assets on a network;
providing an asset controller according to claim 1;
the load determination unit establishing power consumption on the network;
the processor identifying at least two of the plurality of assets to operate, in response to the established network power consumption, wherein a first one of the at least two of the plurality of assets has a first response-time significantly less than a second response-time of a second one of the at least two of the plurality of assets; and
the control means individually instructing each of the at least two of the plurality of assets to operate, in response to identification thereof by the processor.
